(19) United States
(12) Patent Application Publication
(10) Pub. No.: US 2016/0014617 A1
(43) Pub. Date: Jan. 14, 2016

(54) Wireless Communication Network Performance and Robustness Tuning and Optimization Using Deviations in Multiple Key Performance Indicators

(71) Applicants: Serkan Sofuoglu, Pleasanton, CA (US); Djakhongir Siradjev, Istanbul (TR)

(72) Inventors: Serkan Sofuoglu, Pleasanton, CA (US); Djakhongir Siradjev, Istanbul (TR)

(73) Assignee: P. I. Works TR Bilisim Hizm. San. ve Tic A.S., Istanbul (TR)

(21) Appl. No.: 14/325,467

(22) Filed: Jul. 8, 2014

(51) Int. Cl. H04W 24/02; H04W 36/00

(52) U.S. Cl. CPC H04W 24/02; H04W 36/0005

(57) ABSTRACT

A system and method for dynamically improving or optimizing the performance and robustness of a wireless communication network such as a mobile communication system or cellular telephony network are disclosed. In some aspects, a plurality of time and space dependent key performance indicators (KPI) are used as part of a statistical determination of a pattern and schedule for optimizing the design, configuration and operation of the network. By dynamically applying a method of multiple KPI deviations the system and method improves handover execution in cellular or similar systems and reduces radio link failures and improves overall subscriber service quality.

### TECHNICAL FIELD

The present disclosure generally relates to the field of wireless communication networks. More specifically, it relates to dynamically improving or optimizing the performance and robustness of such networks using a plurality of key performance indicators (KPI) as well as data gathering and statistical techniques to analyze the KPI.

### BACKGROUND

Implementing wireless communication networks in real life environments is typically a challenging and complex undertaking. The complexities of such networks arise from numerous factors. One set of factors includes the physical communication channels in the presence of urban structures, natural terrain, atmospheric variations and other environmental factors. Another set of factors arises from the engineering systems needed to support wireless communications over useful ranges, which includes the antenna designs and placements, communication base station hardware and software, wired communication infrastructure, switching and other maintenance and upkeep factors. Yet another set of factors arises from the mobile wireless devices and their sheer numbers in some areas, each requiring real-time and acceptable quality of service around the clock. All together, the infrastructure and devices and techniques used to interconnect the parts of the system can be referred to as a mobile communication system (sometimes “MCS”). A primary goal of MCS system designers and operators is to implement and operate the MCS system in the most reliable, robust and efficient manner so as to serve the largest number of customers with the highest level of quality at a most cost effective rate.

One primary example of MCS systems and networks are the cellular telephone communication systems and networks, which vary from region to region but share some physical and design and performance features. These systems generally include a network of base stations including telephony processors and servers coupled to physical antenna installations. The antenna installations permit over the air wireless communication with suitably equipped and subscribing customers. In most or all cases, a mobile communication device can continue a communication session even when traversing from one cell of the cellular network to another using established hand-off methods. A well designed and operated cellular system offers consistent good quality communication with few loss of communication problems (dropped calls) or disruptions due to hand-off events, interference, fading or other noise generating factors. The settings of various controlling parameters in mobile communication systems (MCS) significantly affect various dimensions of performance of mobile devices, which are connected to and utilize the services provided by the MCS. In the prior art MCS and prior art standards and practices used to govern the MCS, improvements to such performance of mobile devices under conditions of mobility are referred to as “mobility robustness” improvements, which seek to improve the success rates of handover of the mobile device from one connected entity to another in the MCS and eventually improve drop call rates.

Base Stations are network elements to which mobile user devices are connected in the MCS using radio channels. Handover is a mechanism of the MCS whereby a user mobile device is assigned different primary Base Stations to connect to as the mobile user devices move around the coverage areas of a MCS. Manual setting of handover (HO) parameters in current 2G/3G/4G systems is a time consuming task. In many cases, it is considered too costly to update the mobility parameters after initial deployment. Incorrect HO parameter settings can negatively affect user experience and wasted network resources by causing HO ping-pongs, HO failures, and radio link failures (RLF). While HO failures that do not lead to radio link failures (RLF) are often recoverable and transparent to the user, RLFs caused by incorrect HO parameter settings have a combined impact on user experience and network resources.

A number of metrics are defined to characterize the performance or robustness of an MCS. The metrics are referred to as Key Performance Indicators (KPI). However, merely defining such metrics does not help improve the performance and robustness of networks, especially in dynamic conditions that are subject to time variation. The art lacks well-studied and reliable ways to predict and account for such dynamic network conditions. There have been various attempts to provide solutions to achieving maximum performance efficiency of the MCS.

Application US2005/0064820 purports to disclose analyzing of a wired/wireless network and to optimize performance of the network by gathering data continuously from elements constituting a wired or wireless network to find an element of which performance and efficiency deteriorates. An optimal plan to resolve low performance is chosen through data analysis. Application US2007/0002759 purports to disclose a method for monitoring system conditions for time periods within a periodic time interval within which network parameters for optimizing a wireless may be determined. And Application US2013/0143561 purports to disclose a computing platform provided to enable optimizing a cellular network by gathering data, retrieving statistical KPIs from a plurality of network elements, generating a predictive Key Performance Indicator by correlating information from the network elements and retrieved KPIs, and to trigger changes to the cellular network based on the predicted trend.

Prior art solutions do not provide an adequate solution to the problem of optimization of the MCS on the dimension of mobility performance while at the same time allowing maximum improvements to be achieved to other measures of network performance such as data transfer efficiency.

### SUMMARY

An objective of mobility robustness optimization (MRO) is reducing the number of handoff (HO) related radio link failures. Furthermore, non-optimal configuration of handover parameters, even if it does not result in RLFs, may lead to serious degradation of the service performance. An example of such a situation is incorrect setting of the HO hysteresis parameter, which may cause a ping-pong effect (bouncing rapidly between connections with different neighboring Base Stations) or prolonged connection to a non-optimal cell. Another objective will be reduction of the inefficient use of network resources due to unnecessary or missed handovers, which can result from failures due to late HO triggering, early HO triggering and HO to an incorrect cell.

Accordingly, aspects of this invention are directed to using certain mobility parameters that are monitored and modified to optimize the performance of wireless communication services in a MCS. Control parameters are selected, changed, and the impact of such changes on multiple key performance indicators (KPI) are monitored according to a particular pattern and schedule, using the technique of multiple KPI deviations (MKD). A well-defined set of mobility robustness optimization (MRO) changes are applied on selected badly performing regions of the MCS for a specified period of time with the goal of improving handover execution success by reducing radio link failures and with controlled impact on specific services (e.g., down-link data throughput). Results can then be evaluated to find the optimum set of changes to achieve performance improvements of the steady-state behavior of the MCS.

In an aspect, the present concepts can be applied for example, but not only, to multi-technology MCS (e.g., Third Generation and Fourth Generation MCS) using a closed-loop optimization processor to improve numerous operating parameters such as downlink data throughput, handover success rates, and other factors.

### BRIEF DESCRIPTION OF THE DRAWINGS

For a fuller understanding of the nature and advantages of the present concepts, reference is made to the following detailed description of preferred embodiments and in connection with the accompanying drawings, in which:

FIG. 1 schematically illustrates an exemplary MRO MKD system according to one configuration;

FIG. 2 illustrates another exemplary architecture for carrying out the present method;

FIG. 3 illustrates a process for monitoring, learning and applying optimum solution sets to multiple KPI in a MCS; and

FIG. 4 illustrates exemplary phases of MRO-MKD operation.

### DETAILED DESCRIPTION

The operator of the MCS is continually seeking new techniques for running their dynamic and complex networks at maximum efficiency. Performance optimization techniques are employed to make systematic changes to performance-affecting parameters stored in the network in order to ensure the best possible performance for users of the various services provided by the operator, such as data transfer speeds. Indicators (e.g., KPI) are used to determine whether such optimization is needed for parts of the network. These indicators are typically referred to as KPI, which can take the form of formulae composed of performance measurements combined in certain ways to better show the quality of various services along various dimensions of performance. The underlying factors of each KPI are stored in the operational support system (OSS) processor managed by the MCS operator. Optimization processes collect the appropriate KPI data, combine this measurement data into formulae, and evaluate the formulae according to a certain schedule to determine whether the certain network services are operating at maximum efficiency. Changes to the performance-affecting parameters will change the value of the KPI. There are typically many KPI used to determine quality levels of the network. These performance-affecting parameters interact with each other in complex ways and impact the KPI indicators in complex ways. The optimization problem can be defined as a set of techniques to change performance-affecting parameters to achieve desired results of improving certain dimensions of performance of the MCS.

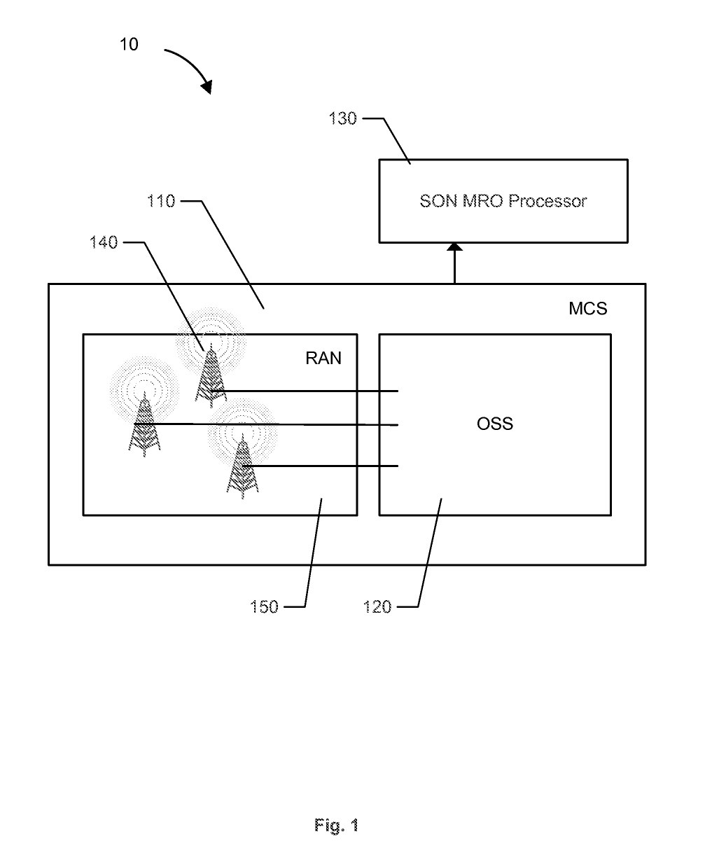

FIG. 1 schematically illustrates a MRO MKD system 10 according to one configuration. The system 10 includes a SON MRO processor 130, which autonomously and dynamically executes programmed operations and instructions according to the design of the multiple KPI optimization system. The operational support system (OSS) 120 contains data regarding the performance and configuration of the MCS 110. Base station node 140 permits communication between mobile units (e.g., cellular mobile telephone subscriber devices) and the wider telephony network. These nodes are sometimes called “NodeB” for Third Generation MCS or “eNodeB” for Fourth Generation MCS. The base station nodes 140 collectively define a radio access network (RAN) 150.

Area selection and special cell exclusion can be performed as part of the design and analysis of the present system and method. For example, exclusions based on a VIP site list, indoor, venue specific sites, border sites, etc. can be excluded or as specified by the MCS operator as in an imported list.

The general operation and function of the system can be understood by analyzing multi-dimensional plots having axes representing the configuration parameters of the system, e.g., time-to-trigger, hysteresis, call drop KPI, handoff failures, and other parameters. Generally, each KPI has its own dependence on the values of the configuration parameters employed by the system. This technique for analyzing, statistically understanding, and controlling for the various configurations so as to control the KPI in a dynamic fashion is an aspect of the present invention. The following plots are to aid visualization of the above notions and illustrate that the performance and robustness of a MCS can depend strongly on configuration parameters as described.

Call drop ratio can be determined as a function of time-to-trigger and hysteresis (dB) in a MCS. Also handover failure ratio can be determined as a function of time-to-trigger and hysteresis according to some embodiments. Such failure ratios can be taken into consideration in optimizing the design and performance of the present system and method.

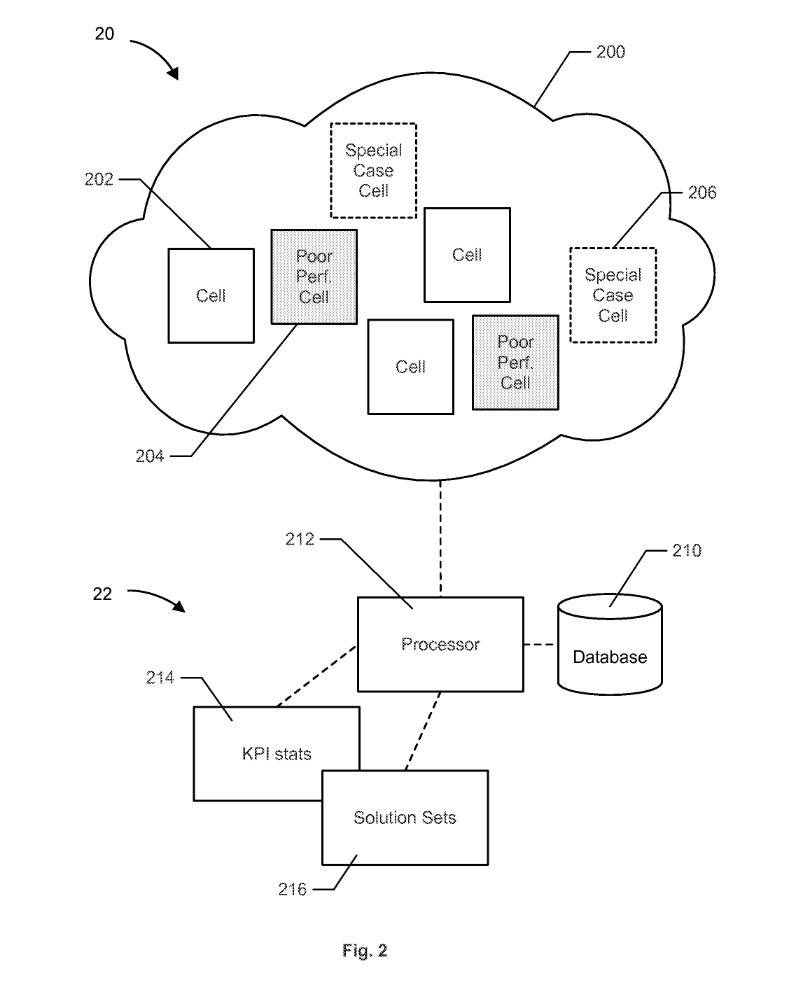

FIG. 2 illustrates an architecture showing a MCS 20 including a plurality of cells (and relations between the cells, or cell relations) in a network 200. The cells include test cells in a target area, poorly performing or worst performing cells, and special case cells to be excluded (202, 204, 206). The cells are monitored by and exchange data with a system 22 including one or more computer processors (desktop computers, workstations, signal processors, etc.) 212, one or more data stores or databases 210. The system 22 also includes one or more modules, engines, or instruction processing elements for calculating solution sets 216 and KPI statistics, deviations and other parameters and metrics 214.

In an aspect, Multiple KPI Deviations (MKD) during optimization of the system and dynamically and iteratively tracking this parameter space is a valuable feature of the present system and method. By assigning appropriate values to the relevant parameters, which can vary in space and time, the operator of the system can tune the behavior of the system for optimum performance and robustness. Ways of using the present MKD method as implemented in its systems include identifying best cost value per cell-period after each configuration parameter change applied, and establishing a reference for parameter rollback decision on the cell level after a certain observation period of time.

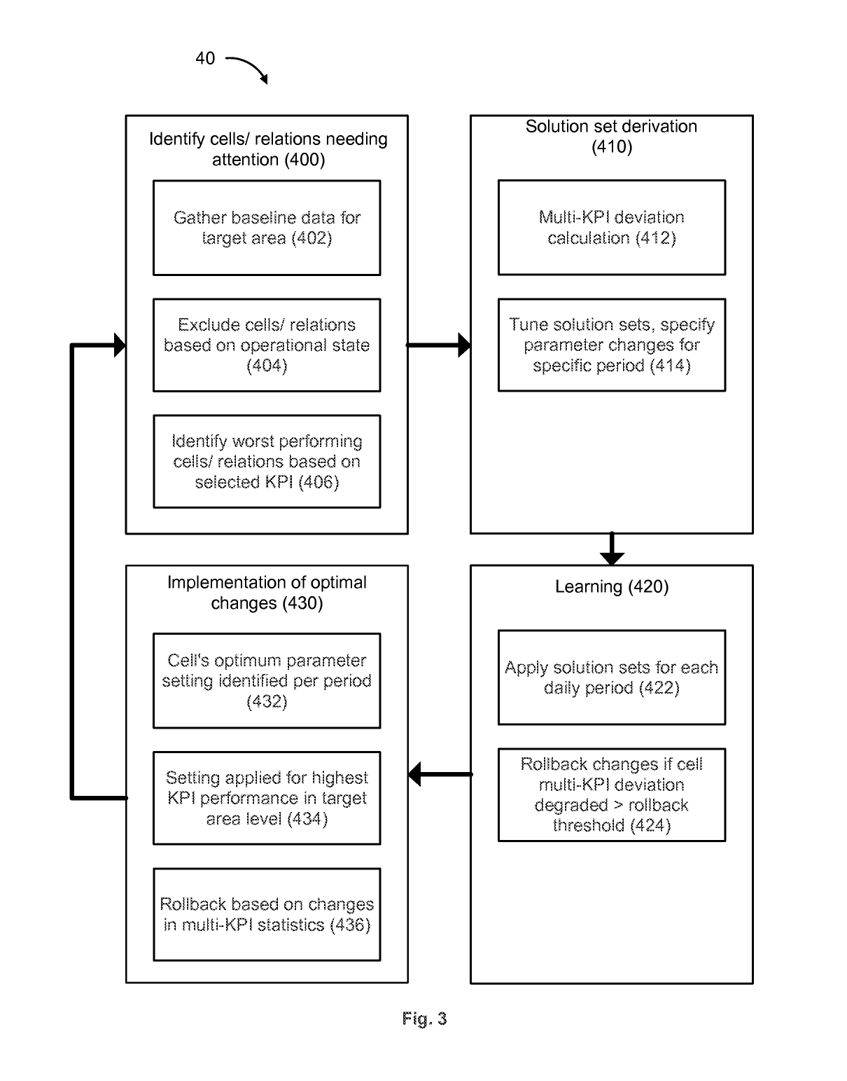

FIG. 3 illustrates an exemplary MRO flow diagram or method 40 according to one or more present embodiments. In some cases, the operator can continuously or iteratively apply the best solution set for each period.

The process may be divided into four main groups of steps, but this is not limiting, as those skilled in the art would appreciate ways to define the process or organize the steps of the method that are equivalent or differ in ways still comprehended by the present disclosure and invention. Here, the main groups of steps are organized for ease of understanding into: identifying cells or relations needing attention 400; solution set derivation 410; learning 420; and implementation of optimal changes 430; after which the method can be repeated as shown.

In the steps for identifying cells or relations needing attention 400, we can define steps to gather baseline data for a target area 402; exclude cells or relations between cells based on operational state 404; and identify worst performing cells or relations between cells based on selected KPI (generally a plurality of selected KPIs) 406. In one embodiment, the system and method can fix common problems after gathering the baseline data for the target area. For example problems due to physical cell identity (PCI) conflicts i.e. collision and confusion scenarios, termination point problems on the X2 link, which need reset operation, far away bad performing relations added automatically by equipment, and others. This allows for filtering and elimination of cells or relations that are the victims of such common operational problems.

A specific rule per use case can be used to identify problematic or non-optimum working area. MRO will try to minimize handover related radio link failures that happen due to too late, too early, and handover to wrong cell scenarios while at the same time prevent ping-pong and unnecessary handovers.

The MRO may have its own set of worst cell/relation selection rules among planned base stations area and related buffer area. The MRO can be focused on the cells with the highest mobility characteristics and with desired minimum target quality index (quality indicator KPI) levels for best results. The MRO is also applied to the worst relations, which are filtered. Measurement period data is used for the planned area and buffer area. In one aspect, the planned area in the form of worst relations will not normally be changed during the learning period where candidate solution sets are applied to network, which could for example be a week long. In practice, during the learning week, the optimization area will show changes due to different cells or cell relations satisfying criteria or filtering thresholds, with new problematic relations arising. These additions and deletions are not usually of the order that would affect the overall results. These new cells and relations however will be taken care of in the following iterations because they will become part of worst area in the next iteration of MRO set of calculations.

Still referring to FIG. 3, in the steps for derivation of a solution set 410, we can define steps to calculate multi-KPI deviation 412 and to tune solution sets, and specify parameter changes for the specific period 414. A notable aspect of the present system and method is that solution sets can be derived for a MCS using multiple KPI and changes in said multiple KPI metrics to identify best solution sets. In an aspect the solution set derivation is dynamic and time variable, for example over defined time periods in a day or other periodicity. In another aspect the solution set derivation can be local in nature, at the cell level in a cellular system, and therefore have global performance and robustness implications.

It has been suggested above that the present method and system can be automated, which in some embodiments can employ techniques of machine or assisted learning, artificial intelligence techniques, or other helpful automation and optimization strategies. In the steps for learning 420, we can define steps to apply solution sets for each daily period 422, which is generalized to any periodicity that is sensible for a given application; and rollback changes if a cell multi-KPI deviation is degraded more than a rollback threshold 424. A well-defined set of optimization changes can be applied on selected worst region for a specified period of time. Results can then be evaluated to find the optimum set to be applied on cell/relation level.

In an aspect, the present system and method can find and tune solution sets iteratively, possibly holding the permanent introduction of the found solution sets into the operation of the MCS until the following stage of the process. This way the operator and/or system can ‘watch’ for the impact of the updated solution sets on the system and decide if and when to implement the same on a permanent basis.

In the steps for implementation of optimal changes 430, we can define steps to identify a cell's optimum parameter setting level identified per period 432; applying the setting for highest KPI performance in the target area 434; and rollback based on changed in multi-KPI statistics 436. In an aspect, the results of the learning process above can be implemented into the daily operation of the MCS after the operator or system is satisfied with the revised solution sets. This may include a statistical study of the actual or predicted impact of such solution sets on the multiple KPI in use.

The steps above can be combined or further divided into sub-processes as suits a given application, and some simplification and generalization is inevitable for the sake of disclosure. Nonetheless, those skilled in the art would appreciate a number of aspects by the present disclosure and exemplary embodiments. In an aspect, it is understood that the above steps could be carried out fully or partially automatically in or by a machine such as a computer or processing apparatus. Typically, such a machine would have circuitry and carry or be adapted to execute stored machine-readable instructions (sometimes encoded into transitory or non-transitory data storage and memory units). In addition to processing and data storage capability, the machine would also typically be equipped with network communication functionality such as input/output ports for receiving and sending electronic signals over such a network. In some aspects, the Internet could be such a network. In other aspects, a wired or wireless telephony network could be connected thereto.

Furthermore, a user interface may be included in the system so that human or non-human users can provide and receive information exchanged with the system. The user interface can include visual and/or audible outputs indicative of relevant information being presented by the system. Graphical depictions of the performance and robustness of the system or MCS it is monitoring and controlling can be displayed and actions can be taken in response thereto. Also, alarm units signaling some pre-determined condition or programmed alarm criterion can be included in the hardware or software of the system. A database unit can be included with or be accessible to the system in which data is stored such as detailed measurement results, data tracking performance and robustness, and other data that can be used for future learning or programming of the system.

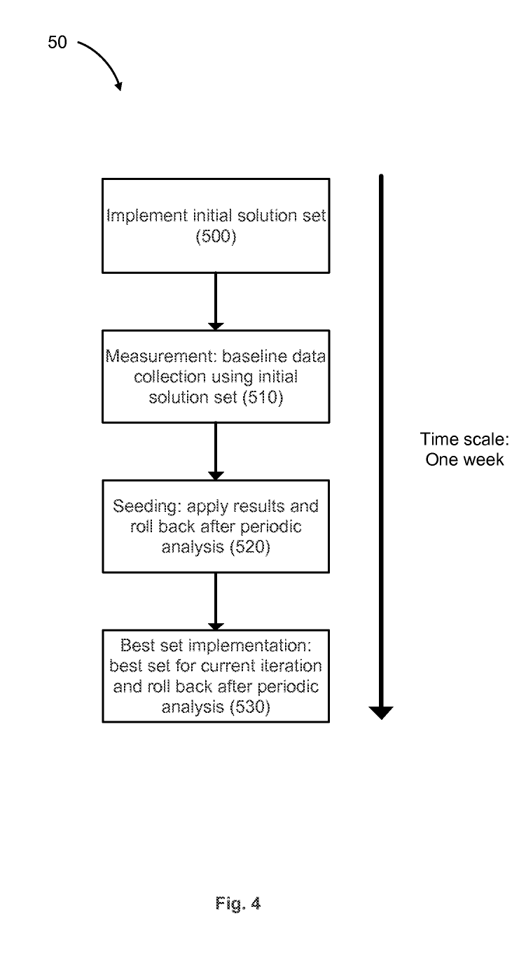

FIG. 4 illustrates an exemplary and simplified flow diagram 50 of the phases of operating the present MRO-MKD system and method in a MCS. The process depicted can have a total time frame of about one week in an embodiment.

In phase 500 we implement the initial solution set or a default set. A solution set here is a combination of one or more configuration parameter settings. The implementation of the parameter settings is again intended to improve overall user and operator experience and quality. This can be based on evaluation of a number of KPI and the solution sets therefore being based on conditions that are satisfied. The conditions can be built-in from prior knowledge from experience and measurements in the field.

In phase 510 we make measurements, collecting baseline data, still using the initial solution set. Statistical information in a typical cellular MCS can be acquired over a month or so of observation (but this is a general statement and good data can be accumulated in two weeks or less also). Measurements are done using cellular and relational performance management data with some minimum resolution for the planned area and buffer area that are collected and stored in this phase.

In an example, each day is divided into three periods: a morning period (P1) from midnight until 8 a.m., an daytime period (P2) from 8 a.m. until 4 p.m., and an evening period (P3) from 4 p.m. until midnight. Of course other periods can also be defined. Data is collected and measurements made in the system, then analysis and calculations are performed on data measured from each of the periods of the day. The data can be organized and labeled, for example, referring to “P1 W1 D1” at Period P1 of Week 1 and Day 1, and so on.

In some aspects, data can be excluded from outlying or special times, days or events so as to avoid contaminating the normal data collection and analysis with outliers.

In phase 520 we seed the system by applying any determined results and rolling back any changes after an hourly analysis of the performance of the system (or any other convenient periodicity). In phase 530 we apply the best solution set for a current iteration, rolling back the results after hourly analysis (or any other convenient periodicity).

The three daily period system described above can be used for seeding the system. Again, the period count and duration are configurable and only exemplary. For a day period, solution sets can be applied for different periods taking into account weekday and weekend days as having different behaviors in some cases. So weekend days can be returned to the initial solution sets to be configured separately. Seeding can extend from one to two weeks in some embodiments. The following table (Table I) shows an example of the seeding process over five days (D) having three periods (P) each, wherein sample seeding is done using two solution sets (SS) in a one week period applied in MRO worst areas.

TABLE I

| | D1 | D2 | D3 | D4 | D5 |
|---|---|---|---|---|---|
| P1 | SS01 | SS01 | SS02 | SS02 | SS01 |
| P2 | SS01 | SS01 | SS02 | SS02 | SS01 |
| P3 | SS01 | SS01 | SS02 | SS02 | SS01 |

The following table (Table II) shows sample seeding for four solution sets in one week period applied to MRO in worst areas. In an embodiment, the solution sets can be returned to the initial or default set at the end of the weekday.

TABLE II

| | D1 | D2 | D3 | D4 | D5 |
|---|---|---|---|---|---|
| P1 | SS01 | SS02 | SS03 | SS04 | SS01 |
| P2 | SS01 | SS02 | SS03 | SS04 | SS01 |
| P3 | SS01 | SS02 | SS03 | SS04 | SS01 |

Rollback triggers can be in effect to avoid adverse effects to network KPI. If after applying a solution set the cell MKD degraded by more than a rollback threshold amount (e.g., 3*delta) for some defined increment delta, this solution set can be rolled back and reverts to the reference set within the next hour or next period.

The present system and method are capable of determining a best solution set implementation. Optimum parameter settings are identified for each period and applied to the MCS, resulting in best KPI performance on a regional level. The best solution set value is applied for a weekday or weekend configuration. The following table (Table III) shows an example of identification of a best multi-KPI deviation at the end of a seeding phase of operation. The underlined solution sets show the best MKD solution set and day/period combinations.

TABLE III

| | | | | | | Best |
|---|---|---|---|---|---|---|
| Cell 1 | D1 | D2 | D3 | D4 | D5 | MKD |
| P1 | SS01 | SS02 | SS03 | SS01 | SS02 | SS03 |
| P2 | SS01 | SS02 | SS03 | SS01 | SS02 | SS01 |
| P3 | SS01 | SS02 | SS03 | SS01 | SS02 | SS02 |

In some embodiments, cell or relation based rollbacks should be applied only for the day the best solution set is applied (e.g., Monday). After Monday, region-based MKD evaluation can be set and a warning report can be generated in case region-based KPI degrade by more than a rollback threshold. (e.g., some 5*delta_standard_region). Of course the specific examples above are only for the sake of illustration and are not limiting.

Therefore, the present system and method have a number of inventive features, some or all of which can improve the performance and robustness of a MCS in various embodiments. The MCS can collect and analyze and use system parameter and configuration information to optimize the performance and robustness of the MCS. The system can learn by statistical observation and iterative determination of best solution sets and then roll out the solution sets found to best affect the MCS at a cell level and in a dynamic fashion based on time periods of the day (or other period). Changes can be rolled back if certain criteria are not met by the changes. This can all be applied in hardware and/or software so that it forms an automated closed-loop means for determining an optimum set of conditions for operating a MCS to increase the quality of the network, reduce dropped calls, improve handoff behavior, and other advantages.

The present system and method can be deployed as stated using a multi-KPI deviation (MKD) calculation. A cost function can be computed in some embodiments to minimize handover (HO) failure rates due to “ping-ponging” of a unit, excessively early or late handoff, or handoff to a wrong cell. This can be implemented for handover success rate KPI improvements. For any day (D) and period (P) of the day we can define KPI directed to such improvements, presented as exemplary KPI, whereas one of skill in the art can appreciate other such KPI:

P1AvgW1WN signifies P1 average for Week1 to WeekN; and

P1StdevW1WN signifies P1 standard deviation for Week1 to WeekN.

Applications of the present MKD method include identifying best cost value per period. For example, Cell A has a best benefit when the corresponding parameter is applied to it during period P1 in a week. In another example, the MKD method is applied for establishing a reference for rollback decisions made on a cell or relation level after some evaluation time interval (for example 60 minutes). More specifically, for example, a rollback to a reference base that happens after applying a set change for Cell A, MKD for a given period (e.g., 9:00 to 10:00 o'clock) which changes the set to (P1AvgW1WN−rollback_coefficient*P1StdevW1WN). In an example, rollback_coefficient can have the value of five (5).

The present system and method can also be deployed using a cell MKD, or cell-based multi KPI standard deviation from a calculated reference. Here the MKD can be used for best solution set evaluation and rollback decisions, if the solution set is directed to cell based configuration parameters. Cell based MKD can include KPI in the form of cells and relations. For relational KPI, aggregation from relations to cell level can be performed. In some embodiments, each KPI has a “class” attached, such as “important,” “sustain,” and “degrade.” These classes have their weights where a KPI can also have a separate weighting within a class. Overall weight is indicated as multiplication of KpiWeight*ClassWeight.

In yet another aspect, the MKD can be relation based on a multi KPI standard deviation from a calculated reference. This MKD will be used for best solution set evaluation and rollback decisions, if the solution set includes relational configuration parameters. In an example, relation based MKD can include the following components during calculation of said deviations: relation based KPI changes from source to neighbor cell (Cell to Ncell); Cell based KPI changes in source cell (Cell); and Cell based KPI changes in neighbor cell (Ncell).

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications and equivalents.

What is claimed is:

1. A computer-implemented method for optimizing performance of a mobile communication system (MCS) in a multi-cell network, comprising:
gathering baseline data for a target area in which the method is to be carried out, including areas containing cells or cell relations for which cell or cell relation performance characteristics are to be extracted based on a plurality of key performance indicators (KPI), and storing said baseline data in a computer-readable database;
determining at least one special case cell or cell relation detrimental to the success of said method, and excluding said special case cells or cell relations from adversely influencing an outcome of said method;
determining a set of worst performing cells or cell relations in said target area;
measuring at least one performance metric of said MCS;
storing data representing said at least one performance metric in said database;
configuring at least one solution set using different configurable sets of operational parameters of said solution set associated with said cells or cell relations on a time period basis;
analyzing in a processor, said stored data representing at least one performance metric, and determining multiple KPI deviations (MKD) in a degree of a statistical deviation from said baseline data;
computing, in a processor, performance gains of said test cells or cell relations across a plurality of KPI, which are output as a unified metric data;
rolling back changes made to the MCS based on said solution sets that result in greater degradation of said performance of said MCS or said KPI than an accepted pre-determined amount; and
dynamically re-configuring at least one solution set based on said analyzing of the stored performance metric and said performance gains.

2. The method of claim 1, determining said MKD comprising a degree of statistical deviation from an average determined from said baseline data.

3. The method of claim 1, further comprising assigning an initial default solution set of parameters which are dependent on said cell and observation time period.

4. The method of claim 1, further comprising iteratively and automatically repeating said steps in a processing system so as to optimize at least one subscriber experience aspect of said MCS.
